(19) United States
(12) Patent Application Publication
(10) Pub. No.: US 2012/0084807 A1
(43) Pub. Date: Apr. 5, 2012

(54) System and Method for Integrating Interactive Advertising Into Real Time Video Content

(76) Inventors: Mark Thompson, Tempe, AZ (US); Earl Cole, Santa Monica, CA (US)

(21) Appl. No.: 13/247,697

(22) Filed: Sep. 28, 2011

Related U.S. Application Data
(60) Provisional application No. 61/404,393, filed on Oct. 4, 2010.

(51) Int. Cl. H04N 7/10

(52) U.S. Cl. 725/32

(57) ABSTRACT

A system and method for interactive video advertising comprising advertising overlays that are displayed on a video screen to prompt user interaction. User interaction causes additional advertising content to be made available in a user interface that may be accessed immediately or at a later time point. Advertising content that populates the user interface is chosen based on marketing and behavioral data and parameters. The user interface allows users to access advertising material, send advertising materials to other users and networks such as social networks, social media, telephone networks, wireless telephone networks, cellular telephone networks, computer networks, cable television networks, satellite television networks, video game system networks, the internet, individuals, or combinations thereof. The types of data and advertising materials that may be shared are videos, pictures, photographs, text messages, sweepstakes, contests, emails, telephone calls, popularity indicators, and combinations thereof.

### CROSS-REFERENCE TO RELATED APPLICATIONS

This application incorporates by reference and claims priority to Provisional Patent Application Ser. No. 61/404,393 filed Oct. 4, 2010.

### FIELD OF THE INVENTION

The present invention is directed toward a system and method for video advertising. More specifically, the invention relates to an in-video advertising interface that allows viewers to react to advertising impressions in real-time.

### BACKGROUND OF THE INVENTION

Targeting video advertisements to appropriate demographics remains a challenge to the advertising field. Video advertisements, whether on traditional television or through streaming Internet content, typically force viewers to watch advertisements that are not relevant for individual viewers. Such advertisements fail to efficiently reach intended audiences.

For interactive content, viewers who click on in-program advertising are typically immediately taken away from such content which is a disincentive to engage interactive advertising, therefore effectively minimizing the efficacy of advertising efforts. Advertisements on YouTube™, for example, may be clicked during video content, but immediately remove the user from the video content being viewed in order to follow what is effectively an Internet hyperlink that leads to alternate content. This is a severe disincentive for users to click on advertisements.

Other forms of video advertising, such as those by GoDaddy.com, are mere suggestions which refer a viewer to visit a website to further view additional advertising content. This necessitates that a viewer record or memorize website addresses to be inputted by the user into a computer system at a later date. This advertising mechanism suffers from numerous disadvantages. Specifically, it relies on a viewer's memory and forces the viewer to undergo a large number of discrete steps such as accessing a computer, opening a web browser, entering link information, and navigating the internet to view advertising content. Additionally, viewers may remain anonymous which is a disadvantage to advertisers who attempt to collect viewer data.

Other advertisers have created interactive video advertising systems that allow advertisements to be accessed from a user interface, yet suffer from the limitation that a user must have a specific digital video recordation device to view such content. Furthermore, these advertisements only originate in advertising content, and there is a need in the advertising marketplace to place interactive advertisements in featured video content.

Accordingly, there is a need for advertisers to both personalize advertising to qualified target demographics while increasing clickthrough rates for interactive video advertising so as to maximize an advertiser's return on investment. Specifically, there is a need for a system that minimizes content interruption while gathering relevant personalized consumer data so that relevant advertisements reach relevant audiences through video, internet, mobile, social media, and traditional advertising vehicles.

### SUMMARY OF THE INVENTION

This invention overcomes many of the current limitations in interactive advertising. In one embodiment, interactive advertising tags appear on a video display to prompt a user's interaction with additional advertising content. This additional advertising content is made available in a user interface, and is accessible by the user at a time point the user chooses. This allows the user to continue to watch the underlying program without interruption, yet still have the opportunity at a later point to further explore additional advertising content. By having the option to watch the underlying program uninterrupted, this removes the disincentive to interact with advertising content. The interface also allows the user to send or forward advertising content to other people, other computer systems, and social networks, thereby maximizing an advertisement's efficacy. The interface also allows a user to make purchases and communicate to other people, other computer systems, and social networks about these purchases.

The system for interactive video advertising contains a video display capable of displaying an advertisement tag, wherein the advertisement tag prompts for user interaction and allows a registry of an interaction history. The video display is a device such as a television, monitor, cable television system, satellite television system, digital video recorder, video game system, portable video game system, digital media receiver, telephone, smartphone, personal digital assistant, computer system, laptop computer, and tablet computing device. The advertisement tag is a visual notification, audible notification, tactile notification, or combination thereof.

Upon display of an advertisement tag, the user is thereby prompted for interaction with the system. By interacting with the system after an advertisement tag is displayed, an interaction history archive, in the form of an advertising cart user interface is populated with an interaction history record. The user interface is a graphical user interface, text-based user interface, audible user interface, or combinations thereof. Additionally, in the user interface there are controls that allow data viewing, saving, deleting, sorting, distributing, or combinations thereof.

The user interacts with the system through a remote control, Bluetooth™ device, infrared device, radio frequency device, computer mouse, trackball, touchpad, pointing stick, keyboard, joystick, game controller, webcam, digital camera, touchscreen, stylus, laser rangefinder, motion sensor, proximity sensor, barcode reader, microphone, RFID tag, or combinations thereof. A file, database, computer memory, computer data storage, computer network file, computer network memory, computer network data storage, or combinations thereof stores the interaction history archive.

The system executes advertisement positioning algorithms that review and prioritize the interaction history created by the user. The data sources used in these algorithms are selected from the group consisting of marketing parameters, advertising data, interaction history archive data, probabilistic market segmentation analysis data, and combinations thereof.

Probabilistic market segmentation analysis algorithms are executed in order to choose and display advertising content based upon the interaction history. The system utilizes data for probabilistic market segmentation analysis algorithms including marketing parameters, advertising data, market data, interaction history archive data, user behavior data, user profile data, external user profile data, external interaction history archive data, external user behavior data, and combinations thereof.

The system saves user profile information to bolster the effectiveness of both probabilistic market segmentation analysis algorithms and advertisement position algorithms. The user profile is comprised of data including user name, user address, user phone number, user address, user email address, user age, user marital status, user income, user education, user ethnicity, user race, user system preferences, user contact preferences, user social media account information, user survey data, user bank account information, user credit card information, user e-commerce account information, user VOIP account information, user instant message account information, and combinations thereof.

Advertising data and content are shared and relayed to other users and networks such as social networks, social media, telephone networks, wireless telephone networks, cellular telephone networks, computer networks, cable television networks, satellite television networks, video game system networks, the internet, individuals, or combinations thereof. The types of data and advertising materials that are shared are videos, pictures, photographs, text messages, sweepstakes, contests, emails, telephone calls, popularity indicators, and combinations thereof.

User interaction history data, probabilistic market segmentation analysis data, and advertisement position analysis data are separately, or in combination, utilized by the system to form product and service suggestions to users. These suggestions appear in the user interface. Additionally, user interaction history data, probabilistic market segmentation analysis data, and advertisement position analysis data are separately, or in combination, utilized by the system to suggest additional video programming for user viewing.

The method for interactive video advertising is a series of steps, including the displaying of video content on a video display wherein an advertisement tag is displayed in conjunction with said video content, the interacting with the system during or after the advertisement tag is displayed, thereby populating an interaction history archive with a record of such interaction, the prioritizing of advertising content based on user preferences, user history, advertising data, marketing parameters, market segmentation analysis, or combinations thereof, the displaying of prioritized advertising content in a user interface, the accessing of the user interface in order to adjust user interface settings or controls, and the distributing of advertising data to other individuals or networks.

The video display utilized in the method for interactive video advertising comprises at least one of a television, monitor, cable television system, satellite television system, digital video recorder, video game system, portable video game system, digital media receiver, telephone, smartphone, personal digital assistant, computer system, laptop computer, and tablet computing device. The advertisement tag displayed comprises either visual notification, audible notification, or tactile notification.

The method of interacting with the advertising tag on the video display is through a remote control, computer mouse, trackball, touchpad, pointing stick, keyboard, joystick, game controller, webcam, digital camera, touchscreen, stylus, laser rangefinder, motion sensor, proximity sensor, barcode, or combinations thereof. Upon interaction, the interaction is saved in an interaction history archive which is stored in a file, database, computer memory, computer data storage, computer network files, computer network memory, computer network data storage, or combinations thereof.

### BRIEF DESCRIPTION OF THE DRAWINGS

For a fuller understanding of the invention, reference is made to the following detailed description, taken in conjunction with the accompanying drawings illustrating various embodiments of the invention:

FIG. 1 is a flow chart showing the major components of the advertising system;

FIG. 2 is a flow chart showing one embodiment of the viewer profile creation scheme; and

FIG. 3 is a flow chart showing one embodiment of the interactive advertisement system.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview of the System

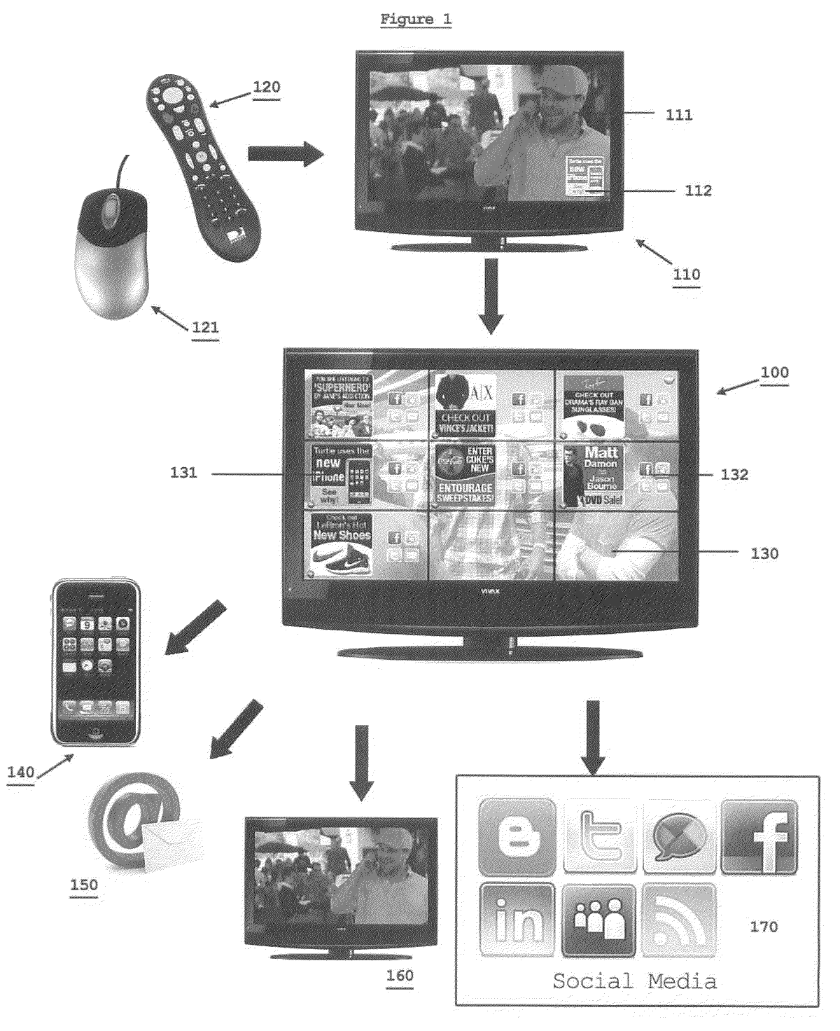

Beginning with FIG. 1, In one embodiment, the central physical component of the system 100, is a video display device 110. The video display device 110, displays video content 111 to the user of the system 100. The video display device 110 is typically a television, video projection system, computer system, tablet device, smartphone, or any device capable of displaying video content 111.

The system 100 can be hardware based, such as integrated into a television, cable box, satellite receiver, digital video recorder (e.g. Tivo™), video game system (e.g. Playstation™, Nintendo wii™), portable video game system (e.g. Nintendo DS™) digital media receiver (e.g. Apple TV™), smartphone (e.g. Android™, Blackberry™, iPhone™), computer based system (e.g. desktop pc, laptop pc, tablet computing device, PDA), or any hardware capable of displaying video content 111. Alternatively, the system 100 may be software based such that no hardware integration is required for operation of system 100. Such systems 100 are embedded in internet sites, internet services, cable services, streaming video content services, or any other mechanism for displaying video content 111 (e.g. Netflix™, Hulu™, GoogleTV™, Vevo™, digital television network websites, cable services) and could be based on either custom software solutions or via means of displaying internet content well established in the art (e.g. Adobe™ Flash™, HTML, XML, CSS, JavaScript, VBScript). Video content 111 includes audio content with or without accompanying video such as exemplified by streaming audio services (e.g. Spotify™, Grooveshark™, Pandora™, Google Music™, Rdio™, or digital cable or satellite TV music channels).

The display device 110 displays advertisement overlays or “tags” 112 over video content 111. A tag 112 is any visual or audible or tactile notification to the user, typically a highlighted region, boxed region, flashing region, vibration, AdBug™, or any other indication that notifies the user that the video content 111 is tagged. Tags 112 appear over video content 111 in real-time for a duration designated by viewer preferences or alternatively by system 100 parameters not accessible by the viewer. Tags 112 highlight physical products, service, songs, persons, scenes, locations, or any video content 111 to which an advertiser wishes to direct a viewer's attention. Inclusion of a tag 112 does not preclude traditional forms of advertisement, such as commercial breaks and pre-roll ads. Commercial breaks may, however, also employ the use of tags 112. Advertisers and programmers utilize a software development kit (SDK) as a tool to tag 112 video content 111. The SDK ensures proper tag placement and timing. Tags are accompanied by metadata not limited to product/service type, genre, brand, scene, location, key words, demographic information, and user profile target parameters.

Users interact with the system 100, by reacting to tags 112 on the video display device 110. The user reacts using an input device 120, 121. Typical user interaction comprises using a remote control 120, computer mouse 121, infrared input device, radio frequency input device, Bluetooth™ input device, RFID device, touch-sensitive screen input, interacting with a motion sensing input device (e.g. Kinect™, iPhone™), or any other form of device input.

Upon user interaction to tags 112, the interaction is recorded by the system 100. The record of interaction is saved locally on the hardware used to access the system 100, and/or is saved remotely in a location accessible by the system 100. The user may access a user interface 130 to access the record of user interactions recorded by the system 100. The user interface 130 is text-based or a graphical user interface. The user interface 130 provides a means to indicate with which tags 112 a viewer has interacted by displaying a tag indication 131, which allows a user to access additional advertising materials.

Tag indications 131 are in icon form, photographic representations, audible cues, textual regions, menus, or any other means to indicate a tag 112 has been selected by the user.

It is possible to sort, delete, save, or send tag indications 131 to other-viewer user interfaces 130. The video content 111 does not need to be stopped or paused upon tag-prompted user interaction with the system 100, and the user may opt to continue viewing uninterrupted video content 111 without first accessing a user interface 130. When the user interface 130 is accessed by the user, the video content 111 may be paused while the user navigates the user interface 130, and upon exit from the user interface 130, the video content is available for continued viewing.

From within the user interface 130, advertising content is relayed to mobile media devices 140, email and traditional mail 150, video display devices 160, social media networks 170, and other digital, electronic, and communications means known or unknown in the art. This advertising content is relayed upon user interaction with controls 132 in the user interface 130 or without any active user interactions.

### User Profile Creation and Analysis

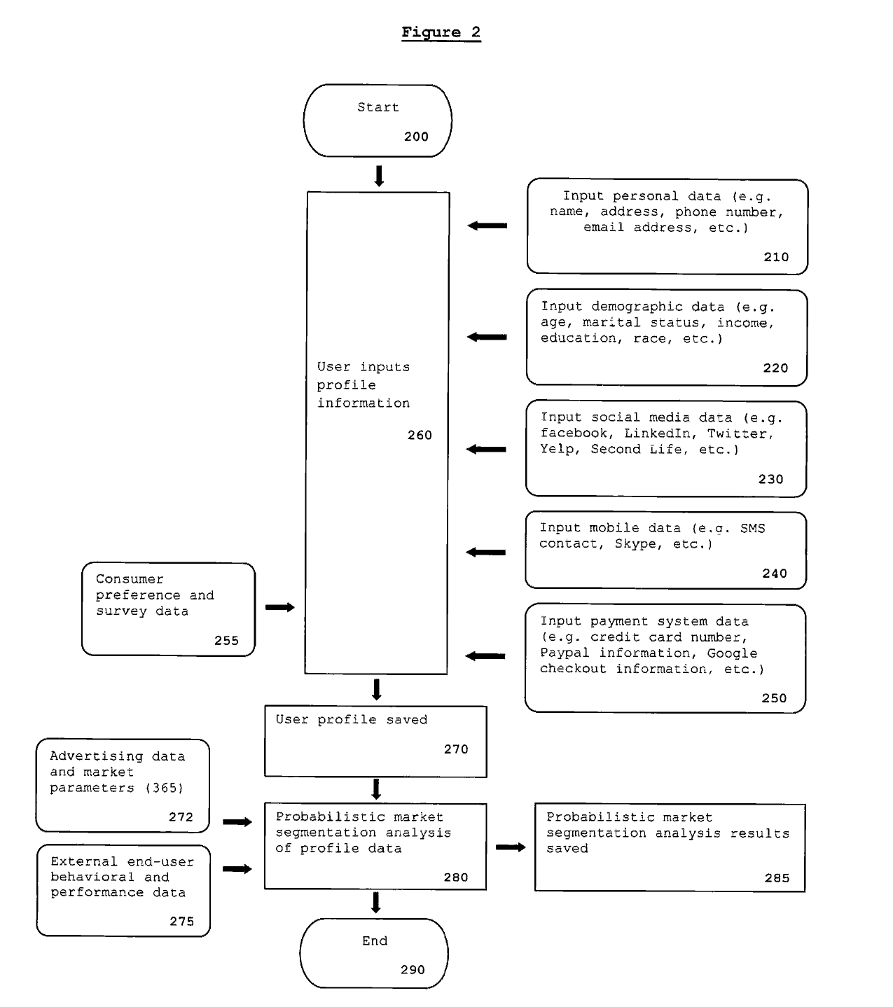

FIG. 2 shows how user profile information 260 may enter the system 100 and the general flow of data for market analyses 270, 272, 275, 280, 285. A user profile may be a compilation of information that may include personal data 210, demographic data 220, social media data, 230, mobile network data 240, payment data 250, consumer preference and survey data 255, or any other data known in the art to be relevant to user profiles and advertising. A user profile 260 is not necessary for the system 100 to function, but will augment calculations 280, 360 designed to target appropriate advertising content 365 to appropriate viewers.

Personal data 210 includes name, address, phone numbers, email addresses, or any other data used to describe or identify an individual user. Demographic data 220 includes age, marital status, income, educational information, race, ethnicity, religion, or any other personal information. Social media data 230 includes account login information, handles or usernames, social network preferences, or any other information related to social media use and accounts. Mobile and communication data 240 includes SMS contact information, geo-location data, voice over internet protocol (VoIP) information, or any other information related to mobile communications, communication technology, and related devices. Payment system data 250 includes credit card information or online payment system information or direct access to financial institutions such as Paypal™ or Google™ checkout, credit card accounts, bank accounts, credit card processors, electronic banking, or any other financial information or access. General survey data 255 includes shopping preferences, advertising preferences, buying habits, online purchasing behavior, brand awareness questions, customer satisfaction surveys, or any other consumer-related preference, behavior, habit, or survey data.

User behavioral data are associated with a user profile 260. These data include information related to recorded interactions with placed products, information about interactions from the user interface 130, how long users remain engaged with advertisements, how users share advertisements and information within their social network 170, what type of advertisements are being saved (or not being saved) for later viewing in the user interface 130, web browser or Internet cookie information, geo-tag information from mobile devices, user contact lists, and other user behavior data known in the art to be useful for advertising purposes. User data are collected to calculate advertising cost per click, cost per mille, cost per engagement, cost per impression, cost per acquisition, and other advertiser cost metrics.

The system 100 saves user profile information 260 in a file or database, or may at an external location in a file or database electronically accessible by the system 100.

The system 100 utilizes user profile information 260 for probabilistic market segmentation analysis (PMSA) 280 and other marketing analytics. PMSA 280 encompasses the use of data and algorithms associated with advertising efforts. PMSA 280 includes the determining of appropriate target audiences, population segments, or individual users of the system 100 for particular advertising content. PMSA 280 includes the determining of advertisement timing, duration, version, content, tagging means, social media outlet choice, digital and electronic communication means choice, or any other advertising choice or strategy employed to maximize advertising efficacy known in the art.

Data provided by advertisers 272, user profile information from external users 275, external-user performance data 275, and other information known in the art to be useful for marketing analyses are also be utilized for PMSA 280.

Data provided by advertisers 272 includes market segment data, price discrimination data, customer retention data, regional market data, product differentiation data, and any other data known in the art utilized to improve marketing and advertising efficacy. These data are used to determine the type, frequency, and duration advertisements to be featured in a user interface 130, the type, frequency, and duration of tags 112, regionally specific advertisement choice, alternate and generic advertisement choice, communication modality choice, and any other choices known in the art made related to maximizing advertising or marketing efficacy.

User profile information from external users 275 includes all the same type of data collected for a local user to be saved in a local user profile 270 and described in detail above. External users include the body of users who access any aspect of the system 100, and includes users with a user profile 260, and those without.

External user performance data 275 includes information related to recorded user interactions with placed products, information from the user interface 130, how long users remain engaged with advertisements, how users share advertisements and information within their social network 170, and what type of advertisements are being saved (or not being saved) for later viewing, web browser or Internet cookie information, geo-tag information from mobile devices, user contact lists, and other external user data or analyses known in the art to be useful for advertising purposes.

### Operation of the System

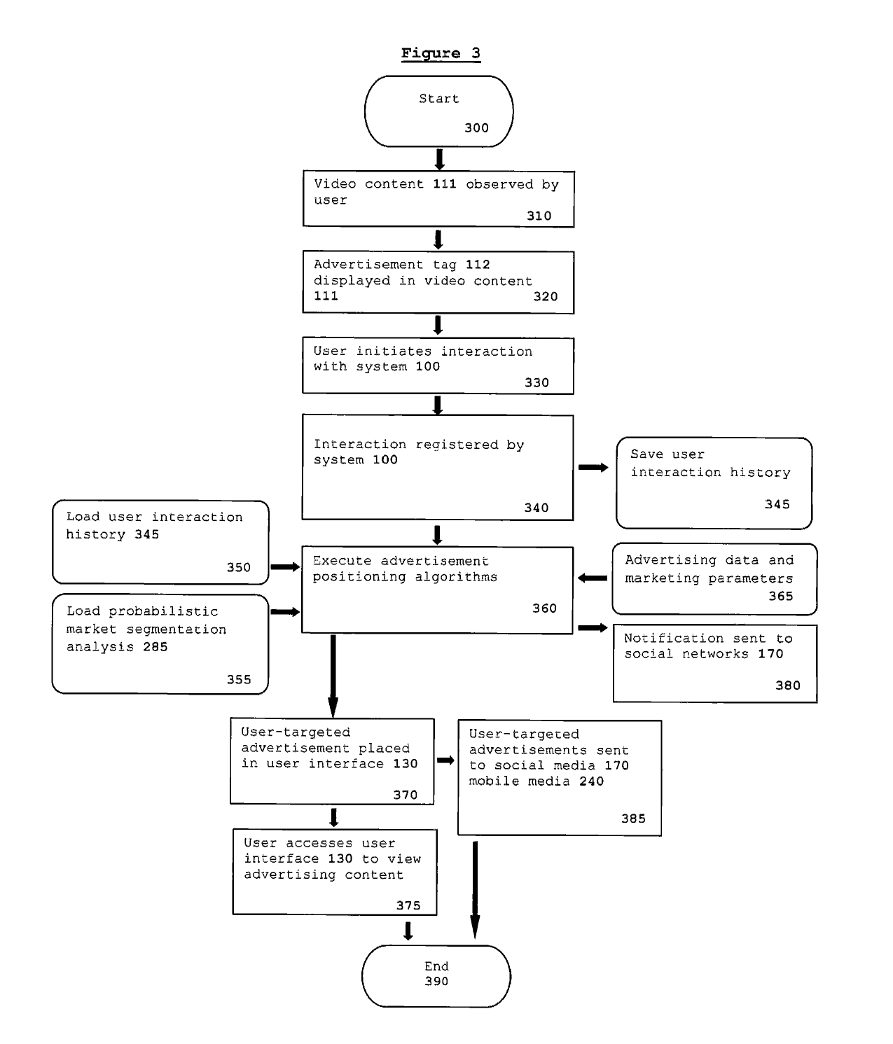

FIG. 3 is a detailed flow chart of one embodiment describing the operation of the system 100. In this preferred embodiment, the process begins when a user observes 310 video content 111 on a display device 110.

In conjunction with video content 111 interactive advertisements may be displayed 320 preferably in the form of tags 112. Displaying 320 tags 112 comprises visual means, audible means, tactile means, or via any other means indicating to a user that a tag 112 is present.

A user initiates an interaction 330 with the system 100 at a time point during or after a a display device 110 displays 320 a tag 112. This user interaction 330 is registered 340 by the system 100, and a history of user interaction is saved 345 for marketing, advertising, or any related system 100 purposes.

Advertisement positioning algorithms 360 utilize saved user interaction history data 345, PMSA data 280, advertising content data 365 and marketing parameters 365, either separately or together, for use in any related system 100 purpose. Advertisement position algorithms 360 are utilized to calculate which particular tag indications 131 and associated advertising or marketing materials are accessible to a user in a user interface 130. Additionally, advertisement position algorithms 360 target particular advertising content 365 to particular users, user groups, demographic groups, social media networks 170, or mailing and distribution lists or any other advertising or marketing outlets known in the art. Notifications to social networks 170 are sent 380 either automatically or as a result of user interaction with controls 132 in the user interface 130. Notifications sent 380 to social networks 170 may be automated, customized, or manually entered messages or advertising materials, or may be popularity indicators such as “Like” notifications found on facebook™ or “+1” notifications found on Google™. From the user interface 130 controls 132, users relay actual advertising content 385 to social media networks 170 and mobile media 140 outlets.

After advertising content 365 is made accessible to a user in the user interface 130, a user navigates the user interface 130, views advertising content 375, and interacts with tag indications 131. Any input device known in the art is used for user navigation of the user interface.

### Method of Integrating Interactive Advertising Content

FIG. 3 provides, by way of example, a method of integrating interactive video content into real-time video content. The method begins when a user observes 310 video content 111. An advertisement tag 112 is then displayed 320 over the video content 111.

A user then initiates an interaction 330 with the system 100 as a reaction to the advertisement tag 112. This interaction 330 is then registered 340 and saved 345 by the system 100.

Advertising content is then prioritized through advertisement positioning algorithms 360. Advertisement positioning algorithms load 350 user interaction history into the system 100. Additionally the system 100 loads 355 probabilistic market segmentation analysis 285 for use by advertisement positioning algorithms. The system 100 also loads 365 advertising data and marketing parameters for use by advertisement positioning algorithms.

Notifications are then automatically sent 380 to social networks 170. User-targeted advertisements are also placed 370 in the user interface 130. A user then accesses the user interface 130 to view 375 a tag indication 131 which allows a viewer to access additional advertising material. Advertising content is then sent 385 by the user from the user interface 130 by interacting with controls 132 found therein.

That which is claimed is:

1. A system for interactive video advertising, the system comprising:
a video display capable of displaying an advertisement tag, wherein the advertisement tag prompts a user interaction and allows a registry of an interaction history;
an interaction history archive in the form of an advertising cart user interface that allows the population and temporal storage of the interaction history;
an advertisement positioning algorithm that reviews and prioritizes the interaction history created by a user acknowledgment of the advertisement tag;
means for allowing probabilistic market segmentation analysis to display advertising content based upon the interaction history which was temporarily stored; and
distribution means for disseminating advertising content.

2. The system for interactive video advertising of claim 1, wherein the video display comprises a device selected from the group consisting of a television, monitor, cable television system, satellite television system, digital video recorder, video game system, portable video game system, digital media receiver, telephone, smartphone, personal digital assistant, computer system, laptop computer, and a tablet computing device.

3. The system for interactive video advertising of claim 1, wherein the advertisement tag comprises at least one of a visual notification, audible notification, and a tactile notification.

4. The system for interactive video advertising of claim 1, wherein the user interaction comprises at least one of a remote control, computer mouse, trackball, touchpad, pointing stick, keyboard, joystick, game controller, webcam, digital camera, touchscreen, stylus, laser rangefinder, motion sensor, proximity sensor, barcode reader, microphone, and RFID tag.

5. The system for interactive video advertising of claim 1, wherein the registry is stored in at least one of a file, database, computer memory, computer data storage, computer network file, computer network memory, and computer network data storage.

6. The system for interactive video advertising claim 1, wherein the interaction history archive is stored in a at least one of a file, database, computer memory, computer data storage, computer network files, computer network memory, and computer network data storage.

7. The system for interactive video advertising of claim 1, further comprising an interaction history archive that is at least one of a graphical user interface, text-based user interface, and audible user interface.

8. The system for interactive video advertising of claim 7, further comprising an interaction history archive having controls that allow data to be at least one of viewed, saved, deleted, sorted, and distributed.

9. The system for interactive video advertising of claim 1, wherein the advertisement positioning algorithm data sources used in calculations are from at least one of marketing parameters, advertising data, interaction history archive data, and probabilistic market segmentation analysis data.

10. The system for interactive video advertising of claim 1, wherein probabilistic market segmentation analysis data are from at least one of marketing parameters, advertising data, market data, interaction history archive data, user behavior data, user profile data, external user profile data, external interaction history archive data, and external user behavior data.

11. The system for interactive video advertising of claim 10, wherein the user profile comprises data selected from at least one of user name, user address, user phone number, user address, user email address, user age, user marital status, user income, user education, user ethnicity, user race, user system preferences, user contact preferences, user social media account information, user survey data, user bank account information, user credit card information, user e-commerce account information, user VOIP account information, and user instant message account information.

12. The system for interactive video advertising of claim 1, wherein the distribution means distributes data to at least one of a social network, telephone network, wireless telephone network, cellular telephone network, computer network, cable television network, satellite television network, video game system network, and the internet.

13. The system for interactive video advertising of claim 1, wherein the distribution means distributes data from the user interface.

14. The system for interactive video advertising of claim 12, wherein advertising content comprises advertising materials selected from at least one of videos, pictures, photographs, text messages, sweepstakes, contests, emails, telephone calls, and popularity indicators.

15. A method for interactive video advertising, the method comprising the steps of:
displaying video content on a video display, wherein an advertisement tag is displayed in conjunction with said video content;
interacting with the video display thereby populating an interaction history archive with a record of such interaction;
associating the record of interaction with advertising content;
prioritizing the advertising content based on user preferences, user history, advertising data, marketing parameters, market segmentation analysis, or combinations thereof;
storing the prioritized advertising content in a user interface;
accessing the user interface in order to adjust user interface settings or controls; and
distributing the advertising content to other individuals or networks.

16. The method for interactive video advertising according to claim 15, wherein the video content displaying comprises a device selected from the group consisting of a television, monitor, cable television system, satellite television system, digital video recorder, video game system, portable video game system, digital media receiver, telephone, smartphone, personal digital assistant, computer system, laptop computer, and tablet computing device.

17. The method for interactive video advertising according to claim 15, wherein the distributing advertising content is from the user interface.

18. The method for interactive video advertising according to claim 15, wherein the interacting with the video display comprises at least one of a remote control, computer mouse, trackball, touchpad, pointing stick, keyboard, joystick, game controller, webcam, digital camera, touchscreen, stylus, laser rangefinder, motion sensor, proximity sensor, and barcode.

19. The method for interactive video advertising according to claim 15, wherein the interaction history archive is stored in at least one of a file, database, computer memory, computer data storage, computer network files, computer network memory, and computer network data storage.

20. The method for interactive video advertising according to claim 15, wherein advertising content is distributed to social media networks.
